(19) United States
(12) Patent Application Publication
(10) Pub. No.: US 2010/0055382 A1
(43) Pub. Date: Mar. 4, 2010

(54) Floor mat

(76) Inventors: Toshie Hatta, Yokohama-shi (JP); Takahisa Takeoka, Isehara-shi (JP); Naoto Ohshima, Yokohama-shi (JP)

Correspondence Address: KENYON & KENYON LLP, ONE BROADWAY, NEW YORK, NY, 10004, US

(21) Appl. No.: 12/584,215

(22) Filed: Sep. 1, 2009

(30) Foreign Application Priority Data
Sep. 4, 2008 (JP) 2008-227078

(51) Int. Cl. B32B 3/30

(52) U.S. Cl. 428/95

(57) ABSTRACT

A floor mat according to the present invention includes a backing layer and a carpet layer formed over the backing layer. The backing layer includes: a backing having a sheet shape; a projection portion which separates the backing from a floor portion; and a through hole which communicates with a space formed between the floor portion and the backing layer, the through hole and the space forming a resonator.

### BACKGROUND OF THE INVENTION

1. Field of the Invention

The present invention relates to a floor mat.

Priority is claimed on Japanese Patent Application No. 2008-227078, filed Sep. 4, 2008, the content of which is incorporated herein by reference.

2. Description of Related Art

The floor mat which has sound proofing properties is well known as described below.

Firstly, a description will be given of a sound proof carpet and a rug mat (floor mat) each of which is formed by layering a textile substrate (carpet layer) on top of a foam resin (backing layer) in which a plurality of through holes are formed.

In this sound proof carpet and rug mat, a portion of the air bubbles in the foam resin are open to the air via the through holes. As a result, the sound absorption coefficient of the foam resin is improved (see Japanese Unexamined Patent Application, First publication Nos. 2002-238730 and 2002-282116—referred to below as Patent document 1 and Patent document 2).

Japanese Unexamined Patent Application, First publication No. 2003-291711, which is referred to below as Patent document 3, discloses a floor mat in which the sound absorption coefficient has been improved by providing a felt layer between a foam backed rubber sheet (backing layer) having air permeability and a carpet ground fabric (carpet layer).

Japanese Unexamined Patent Application, First publication No. 2005-145383, which is referred to below as Patent document 4, discloses a foot panel in which a shock absorbing component having an aperture portion is fitted in a sound absorbing component as an in-vehicle decorative component which has sound proofing properties.

This shock absorbing component has a rib and a footrest plate portion in which an aperture portion is formed. The foot panel is formed by fitting the rib into an engaging groove of the sound absorbing component.

At this time, a space is formed between the footrest plate portion and the sound absorbing component, and the sound absorption coefficient is improved by means of a resonator which uses this space as one of its component elements.

However, the following problems occur in these floor mats.

Firstly, in the backing layer described in Patent documents 1 and 2, it is difficult to selectively absorb a predetermined frequency.

Moreover, in the floor mat described in Patent document 3 as well, it is difficult to selectively absorb a predetermined frequency using the felt layer.

In addition, in Patent document 4 there is a description of how the foot panel of Patent document 4 makes it possible to reduce noise by adjusting the volume of the space and the like. However, the volume of the space varies depending on the fitting accuracy of the shock absorbing component and it is difficult to selectively absorb a predetermined frequency.

Moreover, floor mats in which foam resin is used for the backing layer (see, Patent documents 1 and 2) and floor mats in which a felt layer is provided (see, Patent document 3) have high manufacturing costs. Furthermore, the foot panel described in Patent document 4 has a complex structure in which both a shock absorbing component and a sound absorbing component are provided. Because of this, there are considerable cost increases when this foot panel is used for a floor mat which covers an entire floor surface. Furthermore, for structural reasons, a certain amount of height and volume is necessary so that there are limits on where this foot panel can be installed. In addition, because the resonator holes are exposed, this floor panel has an unattractive appearance and it is difficult to utilize it as a floor mat.

### SUMMARY OF THE INVENTION

It is an object of the present invention to provide a floor mat which makes it possible to improve the sound absorption coefficient of a predetermined frequency by employing a simple structure.

A floor mat according to the present invention includes a backing layer and a carpet layer formed over the backing layer, and the backing layer includes: a backing having a sheet shape; a projection portion which separates the backing from a floor portion; and a through hole which communicates with a space formed between the floor portion and the backing layer, the through hole and the space forming a resonator.

By employing this structure, when the floor mat is laid on the floor portion, the projection portion performs the function of a support pillar, and makes it possible to easily form a space between the backing and the floor portion. Accordingly, according to this floor mat in which the resonator which is formed by the space and the through hole is easily constructed, and it is possible to improve the sound absorption coefficient in predetermined frequencies based on the structure of the resonator, and to thereby reduce noise.

It is preferable that the projection portion have a spike shape.

By employing this structure, even if the projection portion is not arranged in a continuous configuration, because the projection portion supports the floor mat, it is possible to easily form a space and thus construct the resonator. Accordingly, it is possible to reduce noise.

Moreover, if the projection portion has a spike shape, it is possible to reduce the amount of raw materials required for the projection portion compared with if it has a wall shape. Because of this, the weight of the floor mat can be lightened.

Furthermore, if the projection portion has a spike shape, there is a large load on each individual projection portion so that the friction between the projection portion and the floor portion increases. Consequently, it has an advantage that it becomes difficult for the floor mat to slip on the floor portion.

It is preferable that the backing layer further include an outer wall portion provided at a circumferential edge portion of the backing, the outer wall portion surrounding the projection portion.

By employing this structure, because the space between the backing and the floor portion is substantially sealed, it is possible to improve the sound absorption coefficient of the resonator. Accordingly, according to this floor mat, it is possible to reduce noise.

Moreover, the outer wall portion acts as a brake against slipping and it has an advantage of making it difficult for the floor mat to slip on the floor portion.

It is preferable that the floor mat have a structure in which an outer circumferential portion of the floor mat is in contact with the floor portion.

By employing this structure, it is possible to increase the level of air-tightness between the floor mat and the floor portion, and to thereby improve the sound absorption coefficient of the resonator. Accordingly, according to this floor mat, it is possible to further reduce external noise.

Moreover, the outer circumferential portion acts as a brake against slipping and it has an advantage of making it difficult for the floor mat to slip on the floor portion.

It is preferable that the floor mat have a structure in which the outer circumferential portion of the floor mat is bent so as to be contact with the floor portion.

By employing this structure, even if the floor mat is placed in a flat position, a space having a high level of air-tightness can be easily formed between the floor mat and the floor portion, and the sound absorption coefficient can be improved. Accordingly, according to this floor mat, it is not necessary for locations to lay the floor mat to be carefully chosen and the floor mat can be furnished with more universal applicability.

Moreover, the outer circumferential portion acts as a brake against slipping and it has an advantage of making it difficult for the floor mat to slip on the floor portion.

It is preferable that the backing have a protruding portion on the space side of the backing, and the through hole be formed in the protruding portion.

By employing this structure, the volume of the space is contracted as the length of the through hole is extended, so that it is possible to easily adjust the frequency where the sound absorption coefficient of the resonator is high. Accordingly, according to this floor mat, it is possible to effectively reduce noise.

It is preferable that the backing have a recess, and the through hole be formed in the recess.

By employing this structure, the volume of the space is enlarged as the length of the through hole is shortened, so that it is possible to easily adjust the frequency where the sound absorption coefficient of the resonator is high. Accordingly, according to this floor mat, it is possible to effectively reduce noise.

It is preferable that the projection portion be a wall portion which partitions the backing into a plurality of areas.

By employing this structure, the air-tightness of the space is increased, and the sound absorption coefficient of the resonator can be improved. Accordingly, according to this floor mat, it is possible to further reduce noise.

Moreover, the wall portion acts as a brake against slipping and it has an advantage of making it difficult for the floor mat to slip on the floor portion.

It is preferable that a plurality of the through hole be formed in the backing, and the wall portion partition the backing into individual areas for each of the through holes.

By employing this structure, the air-tightness of the space is increased, and the sound absorption coefficient of the resonator can be improved. Accordingly, according to this floor mat, it is possible to further reduce noise.

It is preferable that a thickness of the backing be set individually for each of the areas.

By employing this structure, it is possible to change the volume of each individual space and to thereby improve the sound absorption coefficient in a plurality of different frequencies. Accordingly, according to this floor mat, it is possible to effectively reduce external noise.

It is preferable that a plurality of the wall portion be provided, the pitch width between the wall portions be set individually for each of the areas.

By employing this structure, it is possible to change the volume of each individual space and to thereby improve the sound absorption coefficient in a plurality of different frequencies. Accordingly, according to this floor mat, it is possible to effectively reduce external noise.

It is preferable that a distal end portion of the wall portion have a blade shape.

By employing this structure, the surface area of the wall portion which is in contact with the floor portion is decreased, and the size of the load acting on the distal end portion of the wall portion is increased. Accordingly, according to this floor mat, there is an increase in friction force and it has an advantage that it is difficult for the floor mat to slip on the floor portion.

It is preferable that a projection be formed on a distal end portion of the wall portion.

By employing this structure, as a result of the floor mat being supported by the projection, the size of the load acting on the projection is increased. Accordingly, according to this floor mat, it is possible to increase the friction force and it has an advantage of making it difficult for the floor mat to slip on the floor portion.

It is preferable that a plurality of the through hole be provided, and inner diameters of the through holes be set individually for each of the areas.

By employing this structure, it is possible to alter the shape of each individual resonator. Accordingly, according to this floor mat, it is possible to provide a floor mat having improved sound absorption coefficients in a plurality of different frequencies.

### BRIEF DESCRIPTION OF THE DRAWINGS

FIG. 1 is a schematic plan view showing a floor mat according to a first embodiment of the present invention.

FIG. 2 is a schematic cross-sectional view showing a floor mat taken along a line A-A′ in FIG. 1.

FIG. 3 is a schematic plan view showing an example of the layout of spikes and through holes in the floor mat according to the first embodiment of the present invention.

FIG. 4 is a schematic cross-sectional view showing the basic structure of a Helmholtz resonator.

FIG. 5 is a cross-sectional view showing a floor mat having bent circumferential edge portions according to a first embodiment of the present invention.

FIG. 6 is an enlarged schematic cross-sectional view showing a floor mat according to a variant example of the first embodiment of the present invention.

FIG. 7 is an enlarged schematic cross-sectional view showing a floor mat according to another variant example of the first embodiment of the present invention.

FIG. 8 is a schematic plan view showing a floor mat according to a second embodiment of the present invention.

FIGS. 9A and 9B are schematic cross-sectional views showing a floor mat taken along a line B-B′ in FIG. 8.

FIG. 10 is a schematic plan view showing a floor mat according to a third embodiment of the present invention.

FIG. 11 is a schematic cross-sectional view showing a floor mat taken along a line C-C′ in FIG. 10.

FIGS. 12A and 12B are schematic cross-sectional views showing an example of a backing layer of the floor mat according to the third embodiment of the present invention.

FIG. 13 is an enlarged schematic perspective view showing an example of a shape of a distal end portion of partitioning walls in the floor mat according to the third embodiment of the present invention.

FIG. 14 is an enlarged schematic perspective view showing another example of a shape of a distal end portion of partitioning walls in the floor mat according to the third embodiment of the present invention.

FIG. 15 is an enlarged schematic perspective view showing a floor mat according to a variant example of the third embodiment of the present invention.

FIG. 16 is a schematic perspective view showing a backing layer according to examples of the present invention.

FIG. 17 is a graph showing experiment results for the examples of the present invention.

### DETAILED DESCRIPTION OF THE INVENTION

Floor mats according to embodiments of the present invention will now be described with reference made to the drawings. In the drawings described below, the scales of the various components have been suitably altered in order to make the components a recognizable size.

### First Embodiment

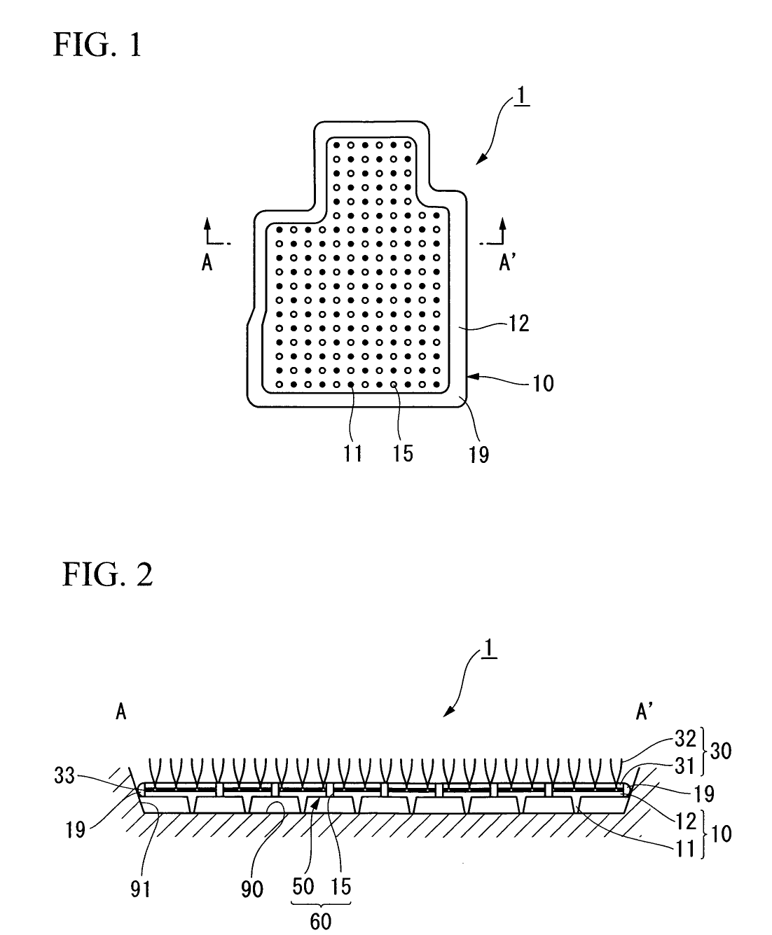

FIG. 1 is a schematic plan view showing a floor mat 1 according to a first embodiment of the present invention as seen from a backing layer 10 side. FIG. 2 is a schematic cross-sectional view showing the floor mat 1 taken along a line A-A′ in FIG. 1.

The floor mat 1 has a structure in which a tuft layer 30 serving as a carpet layer is laid on a backing layer 10. The floor mat 1 is used with the backing layer 10 facing the floor portion 90 side. The carpet layer is not limited to being a tuft layer and it is also possible, for example, for a needle punched layer or a rug layer to be used.

In FIG. 2, the floor mat 1 is installed with an outer circumferential portion 19 of the floor mat 1 touching an inclined surface 91 of a floor portion 90.

As is shown in FIG. 2, a tuft layer 30 includes a ground fabric layer 31 and pile 32.

The ground fabric layer 31 has air permeability and is used as a foundation material onto which the pile 32 is sewn.

The pile 32 alleviates the impact when trodden on by a person or when an object is placed thereon. The pile 32 is sewn onto the ground fabric layer 31 with the pile 32 extending substantially upright in the normal direction of the ground fabric layer 31.

The tuft layer 30 and the backing layer 10 are adhered together by means of an adhesive layer 33.

As is shown in FIG. 1 and FIG. 2, the backing layer 10 includes a sheet-shaped backing 12, a plurality of spikes (projecting portions) 11, and through holes 15.

The spikes 11 are provided on the surface of the backing 12 on the opposite side from the tuft layer 30 (i.e., on the floor portion 90 side).

The spikes 11 support the floor mat 1 and also prevent the floor mat 1 from slipping on the floor portion 90. As is shown in FIG. 2, when the floor mat 1 is laid on the floor portion 90, the spikes 11 support the floor mat 1 so that a space 50 is formed between the backing layer 10 and the floor portion 90.

The spikes 11 may be formed integrally with the backing 12. It is also possible for the spikes 11 to be formed separately from the backing 12 and to then be attached to the backing 12.

The shape of the spikes 11 is not particularly restricted and may be, for example, a circular column shape or a circular truncated cone shape.

The backing 12 has a plurality of through holes 15. The through holes 15 penetrate both the backing layer 12 and the ground cloth layer 31, and connect the space 50 to a space on the outer side of the tuft layer 30.

The shape of the through holes 15 is not particularly restricted. The through holes 15 may have, for example, a circular column shape or a circular truncated cone shape.

In FIG. 1, the spikes 11 and the through holes 15 are arranged in a lattice point pattern whose points are mutually equidistant. However, examples of the layout of the spikes 11 and through holes 15 are not restricted to this.

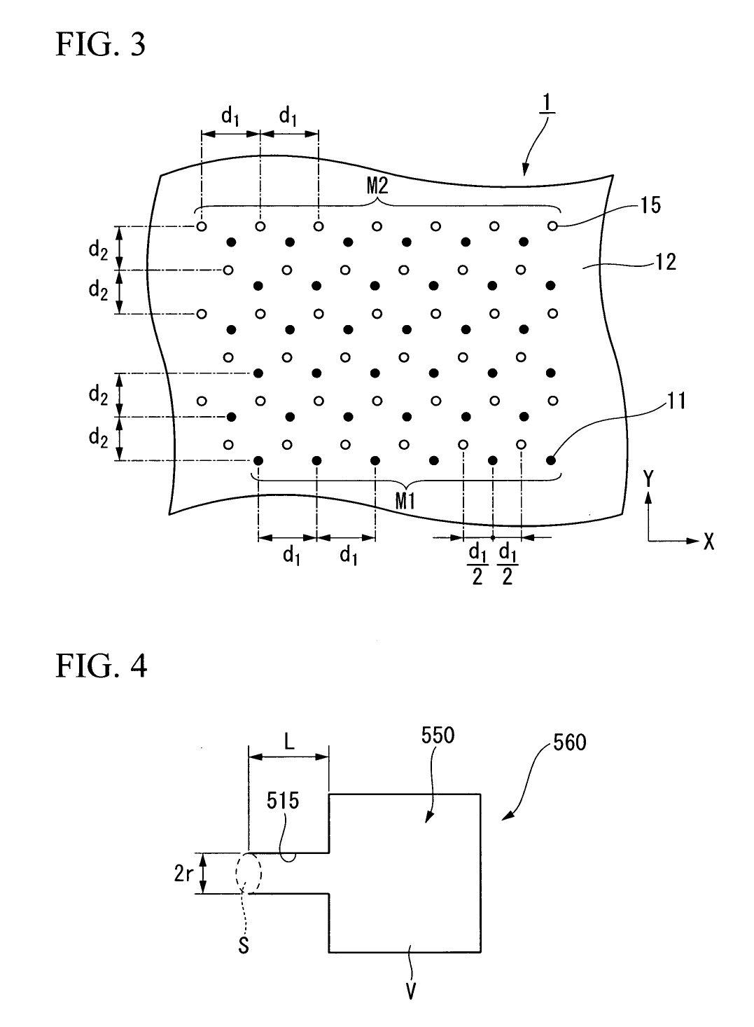

FIG. 3 is a schematic plan view showing another example of the layout of the spikes 11 and through holes 15. In FIG. 3, for convenience, a horizontal direction (i.e., the X axial direction) and a vertical direction (i.e., the Y direction) are defined.

In FIG. 3, the backing 12, the spikes 11, and the through holes 15 are shown.

Rows M1 of the spikes 11 and rows M2 of the through holes 15 extend in the horizontal direction (i.e., in the X axial direction). Moreover, within the rows M1 of the spikes 11 and the rows M2 of the through holes 15, the spikes 11 and the through holes 15 are located respectively at a fixed pitch width d1.

The rows M1 of the spikes 11 and the rows M2 of the through holes 15 are placed alternatingly in the horizontal direction (i.e., in the Y axial direction). Moreover, the rows M1 of the spikes 11 and the rows M2 of the through holes 15 are located respectively at a fixed pitch width d2.

Rows M1 of the spikes 11 which are located adjacent to each other and rows M2 of the through holes 15 which are located adjacent to each other are mutually offset from each other in the row longitudinal direction by a half pitch (d1/2). The spikes 11 and the through holes 15 which have been arranged in this manner are each arranged in a honeycomb pattern. Namely, adjacent spikes 11 are placed in positions which form the apex of an equilateral triangle. In addition, adjacent through holes 15 are placed in positions which form the apex of an equilateral triangle.

The spikes 11 are placed in the center of equilateral triangles formed by the through holes 15. Moreover, the through holes 15 are placed in the center of equilateral triangles formed by the spikes 11.

For example, the spikes 11 and the through holes 15 may be placed at intervals of 12.0 mm (namely, such that d1=12.0 mm) in the horizontal direction (i.e., the X axial direction).

In the vertical direction (i.e., in the Y axial direction), the rows M1 of the spikes 11 and the rows M2 of the through holes 15 are placed at intervals of 10.4 mm (namely, such that d2=10.4 mm).

Further examples of this include placing the spikes 11 and the through holes 15 at intervals of 8.0 mm (namely, such that d1=8.0 mm) in the horizontal direction (i.e., the X axial direction).

In the vertical direction (i.e., in the Y axial direction), the rows M1 of the spikes 11 and the rows M2 of the through holes 15 may be placed at intervals of 6.9 mm (namely, such that d2=6.9 mm).

Returning now to the description of FIG. 2, the floor mat 1 is laid such that substantially the entire circumference of the outer circumferential portion 19 of the floor mat 1 is placed against the inclined surface 91 of the floor portion 90. Namely, apart from the through holes 15, the space 50 is in a substantially sealed state.

The through holes 15 and the space 50 form a resonator 60.

This resonator 60 is known as a Helmholtz resonator and is able to absorb external noise. The sound absorption coefficient of this resonator 60 increases in a predetermined frequency which is determined based on the shape of the resonator 60.

A brief description will now be given of the principle behind a Helmholtz resonator. FIG. 4 is a schematic cross-sectional view showing the basic structure of a Helmholtz resonator. A resonator 560 is formed by a port portion (i.e., a through hole) 515 and by a space 550.

In FIG. 14, r is the aperture radius of the port portion, S is the aperture surface area of the port portion, L is the port length, and V is the volume of the space.

Firstly, external noise is introduced into the resonator 560 via the port portion 515. A broad combination of frequencies are included in the noise introduced into the resonator 560. The resonator 560 creates a single-resonance state in a predetermined frequency which is based on the shape of the resonator 560, and absorbs noise in that frequency.

The resonance frequency f₀ at this time is expressed by the following Formula (1).

f₀=C/(2π)×(S/(V×L1))^{1/2} (1)

Here, C is the velocity of sound and L1 is the compensated port length (L1=L+1.3×r).

Formula (1) is a formula for calculating the resonance frequency when a single port portion 515 is provided. In contrast to this, the resonance frequency f₀ when a plurality of port portions 515 are provided is expressed by the following Formula (2).

f₀=C/(2π)×(N×S/(V×L1))^{1/2} (2)

Here, N is the number of port portions.

Namely, Formula (2) is a formula in which the aperture surface area for the space 550 is compensated in accordance with the number of port portions 515.

When altering the resonance frequency of the resonator 560, it is possible to estimate the trend thereof from Formula (1) or Formula (2).

For example, when altering the resonance frequency to higher frequency, it is required to construct a resonator in which at least one of or a combination of the following conditions is satisfied.
the aperture surface area S of the port portion 515 is increased
the volume V of the space 550 is reduced
the port length L is shortened

In contrast, when altering the resonance frequency to lower frequency, it is required to construct a resonator in which at least one of or a combination of the following conditions is satisfied.
the aperture surface area S of the port portion 515 is reduced
the volume V of the space 550 is increased
the port length L is lengthened

Because air is strongly introduced into and discharged from the port portion 515 of a resonator 560 which is in a single-resonance state, friction is created between molecules in the air. As a result, sound energy is converted into heat energy and the external noise is absorbed.

We will now return to the description of the present embodiment.

The volume of the space 50 is altered by changing the height and width of the spikes 11.

The port length L is the length of the through holes 15, and is altered by changing the plate thickness of the backing 12.

However, any alteration of the volume of the space 50 and the port length L is performed within an extent which allows the floor mat 1 to be laid with stability.

The plate thickness of the backing 12 (i.e., the port length L) is preferably 1 mm or more so as to provide sufficient strength in the floor mat 1. The inner diameter (=2r) of the through holes 15 is preferably 1 mm or more.

The resonance frequency of the resonator 60 can be appropriately altered in accordance with the position where the floor mat 1 is installed.

As an example of this, when the floor mat 1 is installed inside a vehicle compartment, the resonator 60 can be designed to have a resonance frequency of approximately 1000 Hz through 3000 Hz in order to suppress noise inside the vehicle.

A floor mat 1 which has this type of structure allows the following effects to be obtained.

When the floor mat 1 is laid on the floor portion 90, the spikes 11 perform the function of support pillars, and make it possible to easily form the space 50 having a predetermined volume between the backing 12 and the floor portion 90. Accordingly, the resonator 60 which is formed by the space 50 and the through holes 15 can be easily constructed, and is able to resonate with a predetermined frequency which is based on the structure of the resonator 60. As a result, the floor mat 1 allows the sound absorption coefficient in this resonance frequency to be improved and makes it possible to reduce noise.

Even if the spikes 11 are not arranged continuously, the spikes 11 are able to support the floor mat 1 and easily form the space 50. Accordingly, it is possible to construct the resonator 60 and reduce noise.

By constructing the placement portions by which the floor mat 1 is supported on the floor portion 90 in the shape of spikes, it is possible to decrease the quantity of raw materials used compared with the quantity required to make walls. Accordingly, this is effective in both reducing manufacturing costs and reducing the weight of the floor mat 1.

Moreover, because a larger load is imposed on each spike 11 so that the friction between the spikes 11 and the floor portion 90 increases, the floor mat 1 can be prevented from slipping on the floor portion 90.

Because it is possible to alter the volume of the space 50 by changing the height or width of the spikes 11, it is possible to easily adjust the resonance frequency of the resonator 60.

Moreover, because it is possible to alter the length of the through holes 15 (i.e., the port length L) by changing the plate thickness of the backing 12, it is possible to easily adjust the resonance frequency of the resonator 60.

Accordingly, it is possible to set the resonance frequency of the resonator 60 so as to match the noise in the environment in which it is used, and to thereby effectively reduce noise.

By providing a plurality of through holes 15 in the backing 12, it is possible to increase the aperture surface area of the space 50. As a result of this, it is possible to increase the level of sound absorption in the resonator 60, and to thereby effectively reduce noise.

It is also possible for the through holes 15 to be shortened so that they do not penetrate the ground cloth layer 31. As a result of this, although the effect is somewhat deteriorated, it is still possible to obtain a sufficient noise reduction effect.

If the side walls of the through holes 15 are formed in a tapered shape (i.e., if the through holes 15 are formed as circular truncated cones), then because the machine processing is simplified, it is possible to shorten the manufacturing process and reduce manufacturing costs.

By making the plate thickness of the backing 12 (i.e., the port length L) 1 mm or greater, it is possible to ensure sufficient strength in the backing layer 10 and sufficient durability in the floor mat 1.

Even if the pile 32 is immersed in water, the length of the through holes 15 (i.e., the port length L) is considerable and a lengthy time is required until the water passes through to the floor portion 90 side. Because of this, it is possible to improve the performance of preventing water leakage onto the floor portion 90. Because a portion of the water is absorbed by the ground cloth layer 31, the amount of water leakage and the speed of water leakage onto the floor portion 90 are reduced. As a result, it is possible to further improve the performance in preventing water leakage.

Even if the through holes 15 penetrate the ground cloth layer 31, it is still possible to improve the performance in preventing water leakage. This is because the through holes 15 (i.e., the port length L) are made longer by the same amount as the thickness of the ground cloth layer 31, so that even if water does directly reach the through holes 15, the speed at which the water penetrates is reduced.

On the other hand, because the space 50 is connected to the tuft 30 side via the through holes 15, even if the floor portion 90 does become wet, it can be easily dried.

By making the inner diameter (=2r) of the through holes 15 equal to or more than 1 mm, it is possible to reliably absorb sound using the resonator 60, and effectively reduce noise.

As a result of outer end portions of the backing 12 being placed against the inclined surface 91, the air-tightness of the space 50 is increased. Because of this, it is possible to improve the sound absorption coefficient of the resonator 60. Accordingly, it is possible to more effectively reduce external noise.

Moreover, the outer circumferential portions 19 of the floor mat 1 act as a brake against slipping and it has an advantage of making it difficult for the floor mat 1 to slip on the floor portion 90.

Moreover, it is also possible for the outer circumferential portions of the floor mat 1 to be made so that they bend towards the floor portion 90 side.

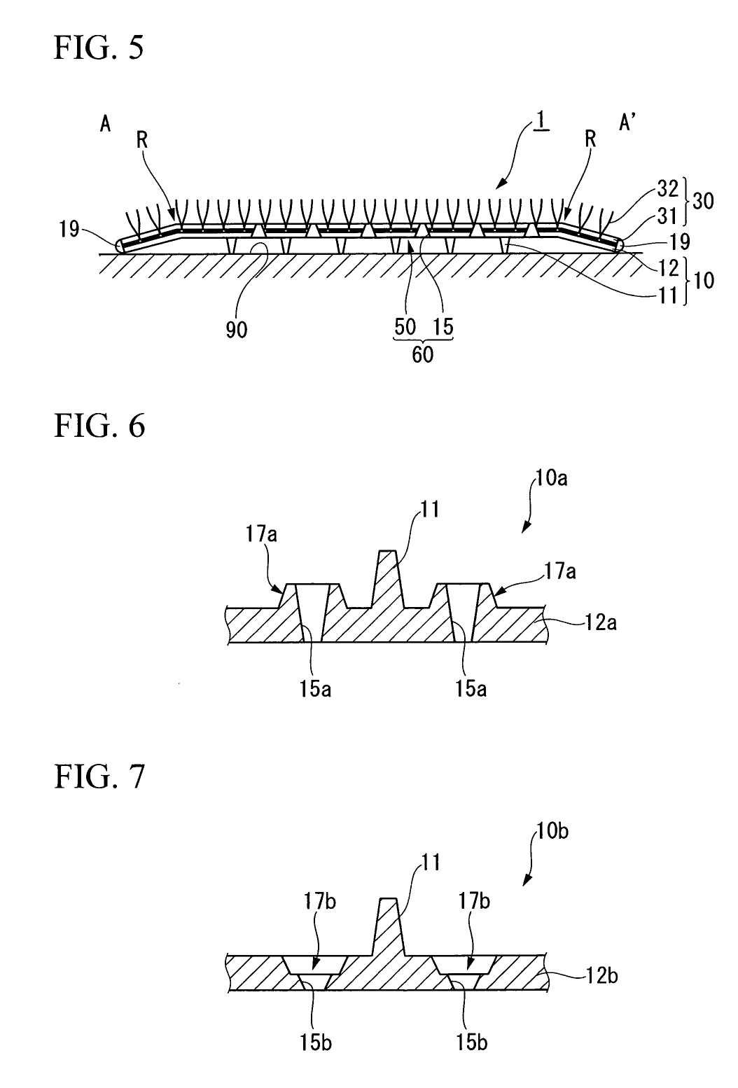

FIG. 5 is a schematic cross-sectional view showing a floor mat 1 having bent outer circumferential portions. As is shown in FIG. 5, this floor mat 1 is bent at the positions R at outer circumferential portions of the mat 1. The outer circumferential portions 19 of the floor mat 1 are in contact with the floor portion 90. In other words, outer circumferential portions of the floor mat 1 are bent towards the side of the spikes 11.

The bends at the positions R can be formed by molding the backing layer 12 in a bent shape. It is also possible for the floor mat 1 to be bent at the positions R as a result of the outer circumferential portions 19 of the floor mat 1 bending under their own weight. In this case, in the vicinity of the outer circumferential portions 19, the spikes 11 are not provided and only the through holes 15 provided to thereby forming the floor mat 1.

As a result of the outer circumferential portions of the floor mat 1 being bent, even if the floor mat 1 is placed in a flat position without the inclined surfaces 91, a space 50 having a high level of air-tightness can be easily formed between the backing 12 and the floor portion 90, and the sound absorption coefficient can be improved. Accordingly, it is not necessary for locations to lay the floor mat 1 to be carefully chosen and it is possible to make a floor mat 1 with more universal applicability.

Moreover, the outer circumferential portions 19 of the floor mat 1 act as a brake against slipping and it has an advantage of making it difficult for the floor mat 1 to slip on the floor portion 90.

The pile 32 may also be sewn through the ground cloth layer 31. By doing this, it is difficult for the sewn pile 32 to pull away from the ground cloth layer 31, and the durability of the floor mat 1 can be improved. Moreover, the pile 32 which is sewn into the ground cloth layer 31 is reliably fixed to the ground cloth layer 31 by the adhesive layer 33, so that the durability of the floor mat 1 can be improved even further.

### Variant Examples

Next, variant examples of the first embodiment will be described. In these variant examples, the shape of the backing 12 in the vicinity of the through holes 15 shown in FIG. 2 is altered. These variant examples are described with reference to drawings.

FIG. 6 and FIG. 7 are enlarged schematic cross-sectional views showing backing layers according to variant examples of the present embodiment.

Firstly, a backing layer shown in FIG. 6 will be described. As is shown in FIG. 6, a backing layer 10a includes backing 12a, spikes 11, through holes 15a, and protruding portions 17a.

The protruding portions 17a are provided on the backing 12a, and adjacent to the spikes 11. A protruding portion 17a is provided for each through hole 15a, and the through holes 15a are formed so as to penetrate the protruding portions 17a and the backing 12a.

The shape of the protruding portions 17a is not particularly restricted, and they may be, for example, a circular column shape or a circular truncated cone shape.

In a resonator which is formed by laying the backing layer 10a on a floor portion, the length of the through holes 15a (i.e., the port length L) is longer than the thickness of the backing 12a. In addition, the volume of the space is smaller by the same amount as the volume of the protruding portions 17a.

Accordingly, by adjusting the shape of the protruding portions 17a, it is possible to alter the resonance frequency of the resonator, and to thereby effectively reduce noise.

Next, a backing layer shown in FIG. 7 will be described. A backing layer 10b shown in FIG. 7 includes a backing 12b, spikes 11, through holes 15b, and recesses 17b.

The recesses 17b are provided in the backing 12b, and adjacent to the spikes 11. The recess 17b is provided for each through hole 15b, and the through holes 15b are formed so as to penetrate the backing 12b from bottom portions of the recesses 17b.

The shape of the recess 17b is not particularly restricted, and they may be, for example, a circular column shape or a circular truncated cone shape.

In a resonator which is formed by laying the backing layer 10b on the floor portion 90, the length of the through holes 15b (i.e., the port length L) is shorter than the thickness of the backing 12b. In addition, the volume of the space is larger by the same amount as the volume of the recesses 17b.

Accordingly, by adjusting the shape of the recesses 17b, it is possible to alter the resonance frequency of the resonator, and thereby effectively reduce noise.

### Second Embodiment

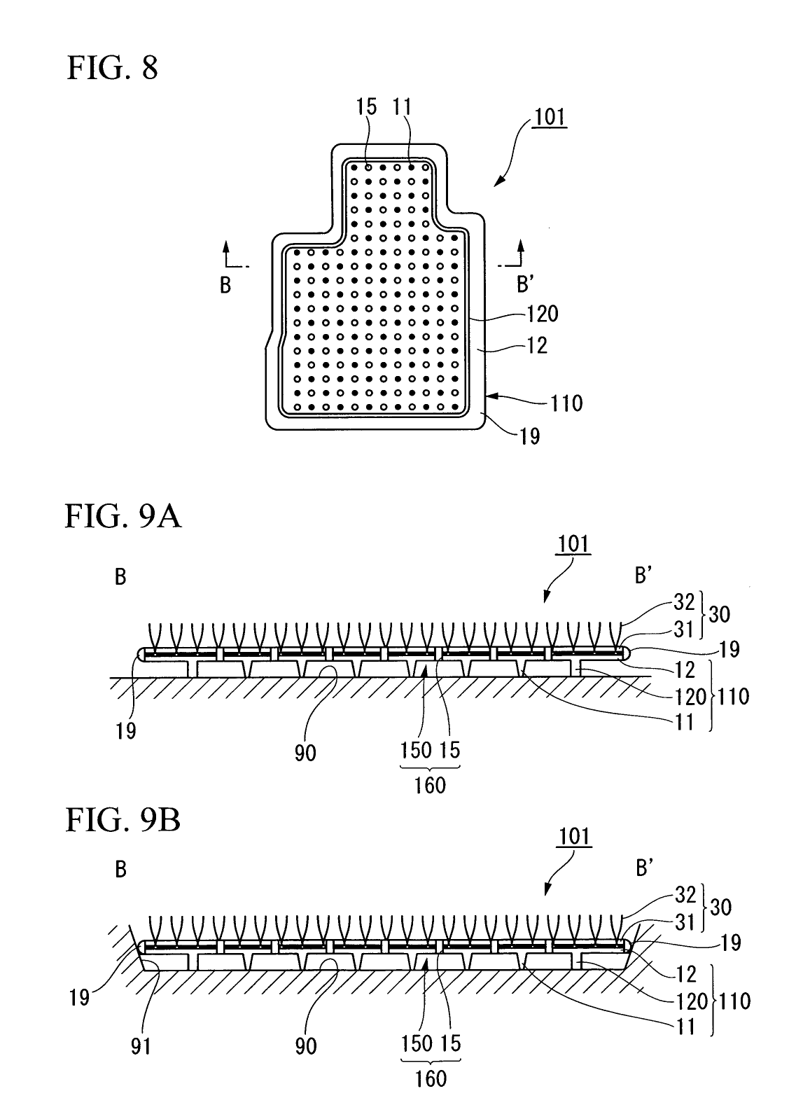

Next, a second embodiment of the present invention will be described. FIG. 8 is a schematic plan view showing a floor mat 101 according to the second embodiment of the present invention as seen from a backing layer 110 side. FIGS. 9A and 9B are schematic cross-sectional views showing the floor mat 101 taken along a line B-B′ in FIG. 8. FIG. 9A shows a case in which the floor mat 101 is laid on a floor surface 90 without the inclined surfaces 91. FIG. 9B shows a case in which outer circumferential portions of the floor mat 101 are placed against the inclined surfaces 91.

The floor mat 101 is formed by the tuft layer 30 and the backing layer 110. Of these, because the tuft layer 30 is the same as that used in the first embodiment a description thereof is omitted here.

The backing layer 110 is formed by the backing 12, the spikes 11, and an outer wall portion 120.

The backing 12 and the spikes 11 are the same as those used in the floor mat 1 of the first embodiment and, therefore, a description thereof is omitted here.

The outer wall portion 120 is provided on the surface of the backing 12 on the same side as the spikes 11. The outer wall portion 120 surrounds all of the spikes 11, and is formed so as to follow the circumferential edge portion of the backing 12.

As is shown in FIG. 9A, the floor mat 101 which is laid on the floor portion 90 is supported by the spikes 11 and the outer wall portion 120. The outer wall portion 120 is in contact with the floor portion 90 over its entire perimeter, and forms a space 150 which is surrounded by the backing 12, the floor portion 90, and the outer wall portion 120. A resonator 160 which is formed by the through holes 15 and the space 150 is thus constructed.

In contrast, outer circumferential portions 19 of the floor mat 101 shown in FIG. 9B are placed against the inclined surfaces 91. In this case, the space 150 is sealed by the outer wall portion 120 and the outer circumferential portions 19 of the floor mat 101.

As a result of the outer wall portion 120 being provided, as is shown in FIG. 9B, because it is possible to form the substantially sealed space 150 even if the floor mat 101 is laid in a location where the inclined surfaces 91 are not provided, it is possible to suppress any sound from leaking out from the space 150. Accordingly, the sound absorption performance of the resonator 160 is raised, and it is possible to improve the sound absorption coefficient.

Moreover, the outer wall portion 120 acts as a brake against slipping and it has an advantage of making it difficult for the floor mat 101 to slip on the floor portion 90.

Furthermore, as was shown in the variant examples of the first embodiment in FIG. 6 and FIG. 7, it is also possible for the backing 12 to have protruding portions or recesses, and for the through holes 15 to be formed in these protruding portions or recesses.

Because it is possible to alter the length of the through holes 15 (i.e., the port length L) and the volume of the space 150, it is possible to easily adjust the resonance frequency of the resonator 160, and to thereby effectively reduce noise.

### Third Embodiment

Next, a third embodiment of the present invention will be described.

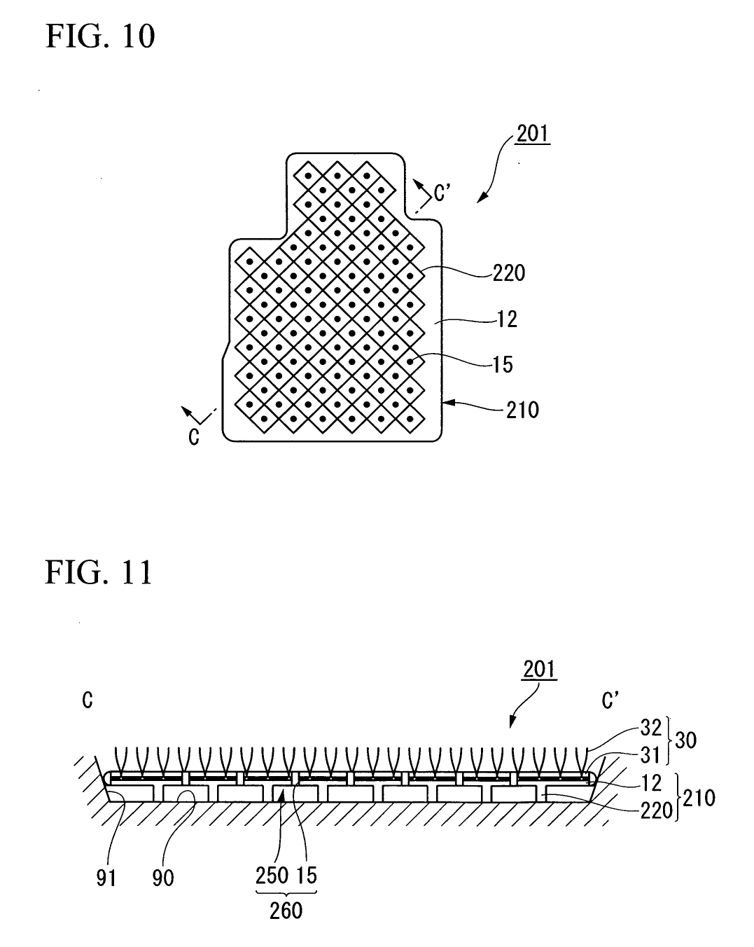

FIG. 10 is a schematic plan view showing a floor mat 201 according to the third embodiment of the present invention as seen from a backing layer 210 side. FIG. 11 is a schematic cross-sectional view showing the floor mat 201 taken along a line C-C′ in FIG. 10.

The floor mat 201 includes the tuft layer 30 and the backing layer 210. Of these, the tuft layer 30 is the same as that used in the first embodiment and, therefore, a description thereof is omitted here.

The backing layer 210 includes the backing 12, the through holes 15, and partitioning walls (projection portions, wall portions) 220. Here, the backing 12 is the same as that used in the floor mats 1 and 101 of the first and second embodiments and a description thereof is therefore omitted.

As is shown in FIG. 10 and FIG. 11, the partitioning walls 220 is provided on the surface of the backing 12 on the opposite side from the tuft layer 30, and extend upright so as to form a lattice pattern in which the surface of the backing 12 is partitioned into square shapes. The partitioning walls 220 divide the planar area of the backing 12 into one partitioned area for each through hole 15.

The partitioning walls 220 may be formed integrally with the backing 12. The partitioning walls 220 may also be formed independently from the backing 12 and then attached to the backing 12.

As is shown in FIG. 11, the floor mat 201 which is laid on the floor portion 90 is supported by the partitioning walls 220. As a result, a space 250 which is surrounded by the backing 12, the floor portion 90, and the partitioning walls 220 is formed for each one of the through holes 15.

A resonator 260 which is formed by the through holes 15 and the spaces 250 is thus constructed.

In the floor mat 201 shown in FIG. 10 and FIG. 11, the plate thickness of the backing 12 and the pitch width of adjacent partitioning walls 220 are kept constant.

As a result of the planar area of the backing 12 being divided by the partitioning walls 220 into one partitioned area for each through hole 15, it is possible to increase the air-tightness of the spaces 250. Accordingly, the sound absorption coefficient of the resonator 260 is improved, and it is possible to reduce noise.

Moreover, the partitioning walls 220 act as a brake against slipping and it has an advantage of making it difficult for the floor mat 201 to slip on the floor portion 90.

The partitioning walls 220 may divide the planar area of the backing 12 into one partitioned area for each through hole 15, or, alternatively, they may divide the planar area of the backing 12 such that each space 250 has a plurality of through holes 15. It is also possible for there to be a mixture of spaces 250 having different numbers of through holes 15.

In these cases as well, because the planar area of the backing 12 is divided into a plurality of areas, it is possible to increase the air-tightness of the spaces 250. Accordingly, the sound absorption coefficient of the resonator 260 is improved, and it is possible to reduce noise.

The plate thickness of the backing 12 and the pitch widths of the partitioning walls 220 may be varied in each of the spaces 250.

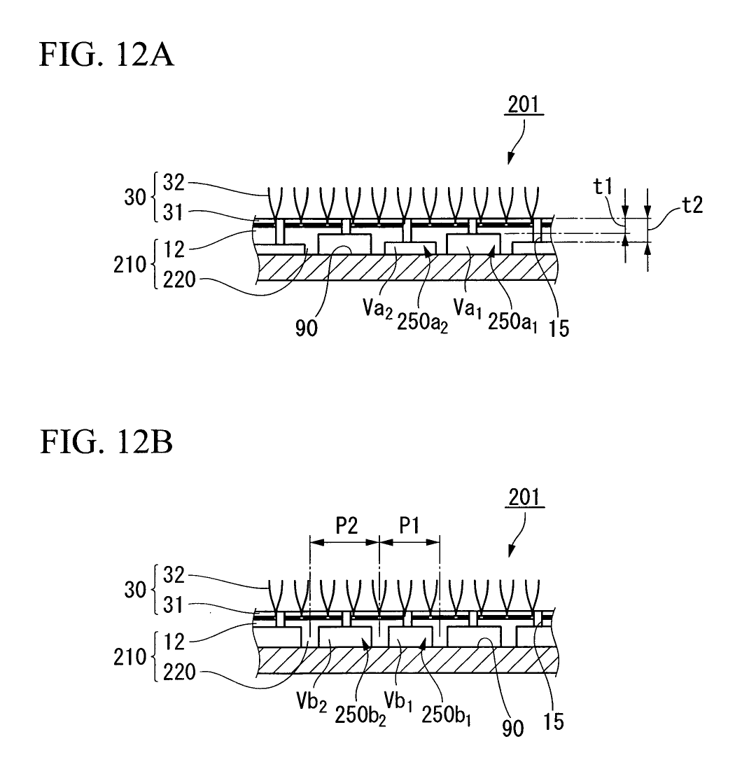

FIG. 12A and FIG. 12B are schematic cross-sectional views showing examples of backing layers 210. FIG. 12A shows an example of a backing layer 210 in which the plate thickness of the backing 12 is altered for each space 250. FIG. 12B shows an example of a backing layer 210 in which the pitch width of the partitioning walls 220 is altered for each space 250.

Firstly, a description will be given of FIG. 12A. In a space 250a₁, the plate thickness of the backing 12 is expressed as a plate thickness t1. In a space 250a₂, the plate thickness of the backing 12 is expressed as a plate thickness t2. The plate thickness t1 is thinner than the plate thickness t2 (t1<t2). The plate thickness is set for each space. The volume of the space 250a₁, is expressed as a volume Va₁. The volume of the space 250a₂ is expressed as a volume Va₂. The volume Va₁ is larger than the volume Va₂ (Va₁>Va₂).

Because it is possible to change the volume of the spaces 250 by setting different thicknesses of the partitioning walls 220 for each space 250, it is possible to improve the sound absorption efficiency in a plurality of different frequencies. Accordingly, it is possible to effectively reduce noise.

Next, FIG. 12B will be described. An interval between adjacent partitioning walls 220 which sandwich a space 250b₁ is expressed as an interval P1. An interval between adjacent partitioning walls 220 which sandwich a space 250b₂ is expressed as an interval P2. The interval P1 is smaller than the interval P2 (P1<P2). The pitch width of the partitioning walls 220 is set for each space. The volume of the space 250b₁ is expressed as a volume Vb₁. The volume of the space 250b₂ is expressed as a volume Vb₂. The volume Vb₁ is smaller than the volume Vb₂ (Vb₁<Vb₂).

By setting different pitch widths of the partitioning walls 220 for each space 250, it is possible to set a different volume in each individual space 250. Because of this, it is possible to improve the sound absorption efficiency in a plurality of different frequencies. Accordingly, it is possible to effectively reduce noise.

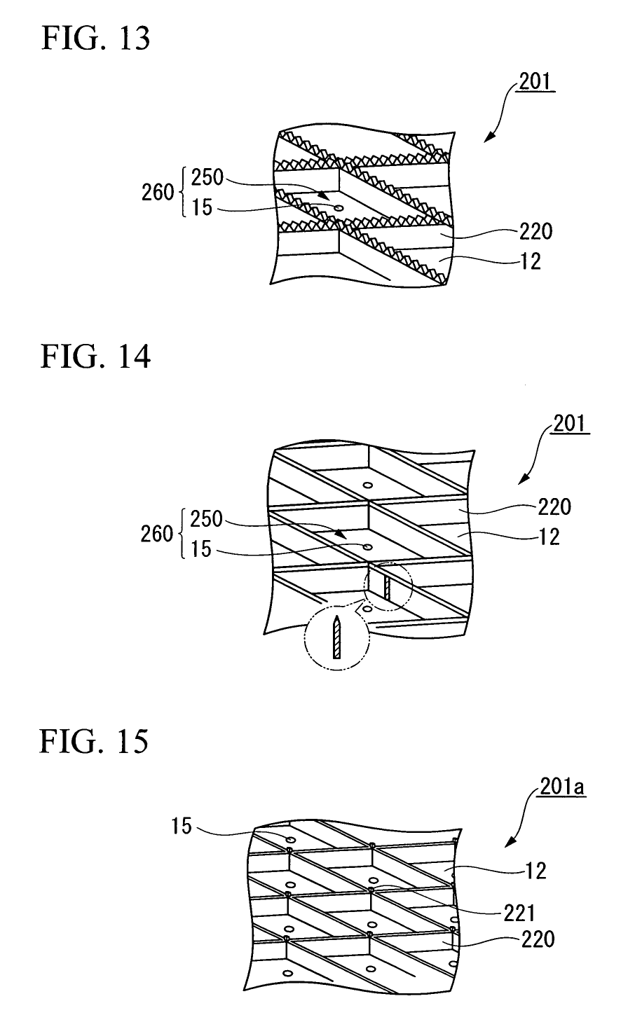

Distal end portions of the partitioning walls 220 have a planar shape. However, they may have a shape other than this. FIG. 13 and FIG. 14 are enlarged perspective views showing examples of shapes of the distal end portions of the partitioning walls 220. Examples of shapes of the distal end portions of the partitioning walls 220 include a saw-tooth pattern shown in FIG. 13 and the blade shape shown in FIG. 14.

If the distal end portions of the partitioning walls 220 are formed in a saw-tooth pattern, then the distal end portions of the partitioning walls 220 are sharpened and even greater pressure is imposed on the distal end portions of the partitioning walls 220. Accordingly, a large friction force is generated between the distal end portions of the partitioning walls 220 and the floor portion 90, and it has an advantage that it becomes even more difficult for the floor mat 201 to slide over the floor portion 90.

Moreover, even if the distal end portions of the partitioning walls 220 are formed in a saw-tooth shape, there is substantially no loss in the air-tightness of the spaces 250 so that the sound absorption coefficient of the resonator 260 can be maintained.

If the distal end portions of the partitioning walls 220 are formed in a blade shape, then the distal end portions of the partitioning walls 220 are sharpened and even greater pressure is imposed on the distal end portions of the partitioning walls 220. Accordingly, a large friction force is generated between the distal end portions of the partitioning walls 220 and the floor portion 90, and it has an advantage that it becomes even more difficult for the floor mat 201 to slide over the floor portion 90.

Moreover, even if the distal end portions of the partitioning walls 220 are formed in a blade shape, substantially the same air-tightness is achieved as when the distal end portions of the partitioning walls 220 are flat, such as is shown in FIG. 11, so that the sound absorption coefficient of the resonator 260 can be maintained.

The inner diameter of the through holes 15 may be set independently in each through hole 15.

By employing this structure, it is possible to change the shape of the port portions of the resonator 260. As a result, it is possible to create a backing layer 210 which has a plurality of resonance frequencies. Accordingly, it is possible to improve the sound absorption coefficient in a plurality of frequencies and effectively reduce external noise.

### Variant Example

Next, a variant example of the third embodiment of the present invention will be described. FIG. 15 is an enlarged schematic perspective view showing a variant example of the third embodiment of the present invention.

As is shown in FIG. 15, a floor mat 201a of the present variant example has projections 221 on the distal end portions of the partitioning walls 220. The positions of the projections 221 are not particularly restricted. However, it is preferable for them to be placed at points of intersection between partitioning walls 220. The shape of the projections 221 is not particularly restricted and may be, for example, a circular column shape or a circular truncated cone shape.

The projections 221 protrude from the distal end portions of the partitioning walls 220. If the floor mat 201a is laid on the floor portion 90, the projections 221 support the floor mat 201a.

The height of the projections 221 is set such that the floor mat 201a is stably supported and such that the air-tightness of the spaces 250 shown in FIG. 11 is not lost.

By providing the projections 221, the surface area of the floor mat 201a which is in contact with the floor portion 90 is reduced, and large pressure is imposed on the projections 221. Accordingly, a large friction force is generated between the projections 221 and the floor portion 90, and it has an advantage that it becomes even more difficult for the floor mat 201a to slide over the floor portion 90.

Moreover, even if the projections 221 are provided, there is substantially no loss in the air-tightness of the spaces 250 so that the sound absorption coefficient of the resonator 260 can be maintained.

Moreover, as is shown in FIG. 6 and FIG. 7, in the same way as in the first and second embodiments, it is also possible for the backing 12 to have protruding portions or recesses.

By employing this structure, it is possible to change the length of the through holes 15 (i.e., the port length L) and the volume of the space 150, and to thereby easily adjust the resonance frequency of the resonator 160. Accordingly, it is possible to effectively reduce external noise.

### Examples

Next, examples of the present invention will be described. In these examples, four types of backing layer were prepared, and the sound absorption coefficient in various frequencies was measured in each backing layer. A method conforming to ISO 10534-2 (Measurement of normal incident sound absorption coefficient) was used for the measurements of these examples.

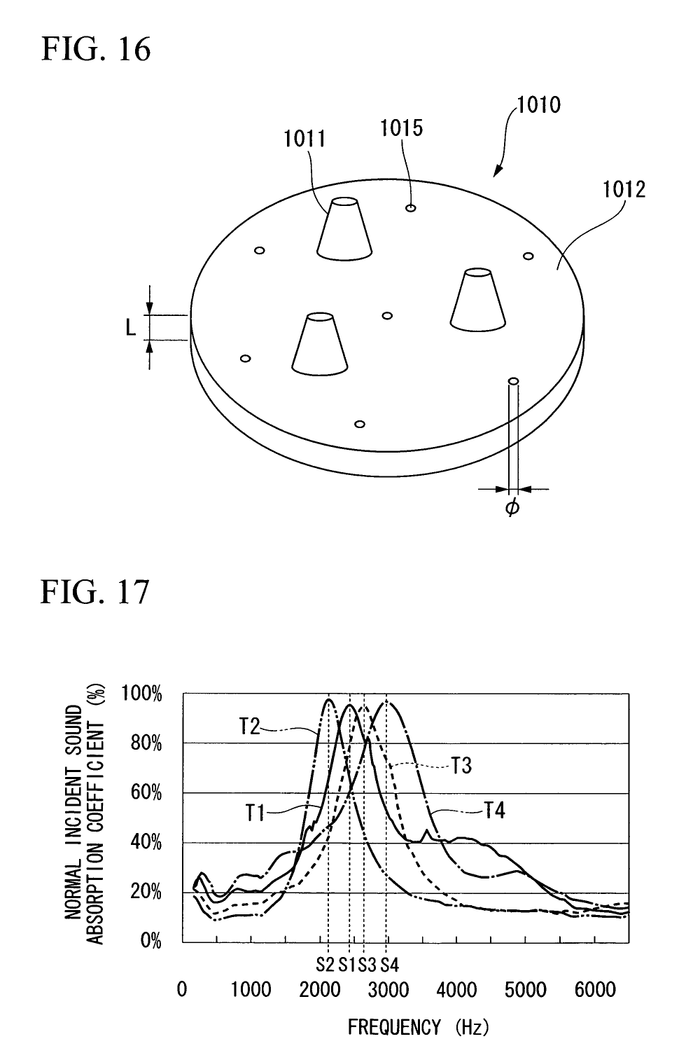

FIG. 16 is a schematic perspective view showing a backing layer 1010 according to these examples. FIG. 17 is a graph showing experiment results from these examples. In FIG. 17, the horizontal axis indicates frequency (Hz), while the vertical axis indicates the sound absorption coefficient (%).

The backing layer 1010 which was prepared will be described first.

Backing 1012 was prepared in the shape of a circular plate having a diameter of 2.9 cm. Seven through holes 1015 were formed in the backing 1012 and three spikes 1011 were mounted on the backing 1012.

Although not shown in the figure, a wall was provided at outer edges of the backing 1012 so that, when the backing 1012 was laid on a floor portion with the spikes 1011 on the bottom side, a circular-cylinder shaped space was formed between the backing 1012 and the floor portion.

In these examples, four types of backing layer 1010 were prepared by changing the plate thickness L of the backing 1012 and the hole diameter φ (=2r) of the through holes 1015.

Specifications of the test samples are given below.

(Test sample 1) Plate thickness L=2.0 mm, hole diameter φ=2.0 mm

(Test sample 2) Plate thickness L=3.0 mm, hole diameter φ=2.0 mm

(Test sample 3) Plate thickness L=3.0 mm, hole diameter φ=2.5 mm

(Test sample 4) Plate thickness L=2.0 mm, hole diameter φ=2.5 mm

The plate thickness L and hole diameter φ described here correspond respectively to the port length L and twice the radius of the aperture of the port portion (2r) which were used in Formula (2).

From these numerical values, the resonance frequencies of the respective backing layers 1010 were calculated. Firstly, the compensated port length L1 used in Formula (2) was as follows in each test sample.

(Test sample 1) Compensated port length L1=3.3 mm

(Test sample 2) Compensated port length L1=4.3 mm

(Test sample 3) Compensated port length L1=4.625 mm

(Test sample 4) Compensated port length L1=3.625 mm

The volumes of each spike 1011 were the same in each case and were set to 0.03665 cm³. Moreover, because seven through holes 1015 were formed, the number N of port portions was seven (N=7).

From the above, the calculated resonance frequencies of the resonators of each test sample were as follows.

(Test sample 1) Resonance frequency f₀=2472 (Hz)

(Test sample 2) Resonance frequency f₀=2165 (Hz)

(Test sample 3) Resonance frequency f₀=2610 (Hz)

(Test sample 4) Resonance frequency f₀=2948 (Hz)

The calculation results are shown in FIG. 17 as calculation values S1 through S4. The calculation value S1 shows the calculation result for Test sample 1. The calculation value S2 shows the calculation result for Test sample 2. The calculation value S3 shows the calculation result for Test sample 3. The calculation value S4 shows the calculation result for Test sample 4.

The experiment results for each test sample are shown by the lines T1 through T4 in FIG. 17. Note that the line T1 shows Experiment result 1 for test sample 1. The line T21 shows Experiment result 2 for test sample 2. The line T3 shows Experiment result 3 for test sample 3. The line T4 shows Experiment result 4 for test sample 4.

The lines T1 through T4 show that the sound absorption coefficient is extremely high in the vicinity of a particular resonance frequency.

The measured resonance frequencies match very closely with the calculated resonance frequencies (i.e., the calculation values S1 through S4).

It was confirmed that in the floor mats of the examples of the present invention, it is possible to easily adjust the absorption frequency by changing the hole diameter φ and the port length L.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A floor mat comprising a backing layer and a carpet layer formed over the backing layer, the backing layer comprising:
a backing having a sheet shape;
a projection portion which separates the backing from a floor portion; and
a through hole which communicates with a space formed between the floor portion and the backing layer, the through hole and the space forming a resonator.

2. The floor mat according to claim 1, wherein the projection portion has a spike shape.

3. The floor mat according to claim 1, wherein the backing layer further comprises an outer wall portion provided at a circumferential edge portion of the backing, the outer wall portion surrounding the projection portion.

4. The floor mat according to claim 1, wherein the floor mat has a structure in which an outer circumferential portion of the floor mat is in contact with the floor portion.

5. The floor mat according to claim 4, wherein the floor mat has a structure in which the outer circumferential portion of the floor mat is bent so as to be contact with the floor portion.

6. The floor mat according to claim 1,
wherein the backing has a protruding portion on the space side of the backing, and the through hole is formed in the protruding portion.

7. The floor mat according to claim 1, wherein the backing has a recess, and the through hole is formed in the recess.

8. The floor mat according to claim 1, wherein the projection portion is a wall portion which partitions the backing into a plurality of areas.

9. The floor mat according to claim 8,
wherein a plurality of the through hole are formed in the backing, and
wherein the wall portion partitions the backing into individual areas for each of the through holes.

10. The floor mat according to claim 8, wherein a thickness of the backing is set individually for each of the areas.

11. The floor mat according to claim 8, wherein a plurality of the wall portion are provided, the pitch width between the wall portions is set individually for each of the areas.

12. The floor mat according to claim 8, wherein a distal end portion of the wall portion has a blade shape.

13. The floor mat according to claim 8, wherein a projection is formed on a distal end portion of the wall portion.

14. The floor mat according to claim 8, wherein a plurality of the through hole are provided, and inner diameters of the through holes are set individually for each of the areas.
